(19) United States
(12) Patent Application Publication
(10) Pub. No.: US 2005/0028839 A1
(43) Pub. Date: Feb. 10, 2005

(54) Method for cleaning fluid spills using biodegradable absorbent material and for transporting the same

(76) Inventor: Malcolm MacQuoid, Park City, UT (US)

Correspondence Address: RANDALL B. BATEMAN;BATEMAN IP LAW GROUP, 4 TRIAD CENTER, SUITE 825, PO BOX 1319, SALT LAKE CITY, UT, 84110, US

(21) Appl. No.: 10/638,216

(22) Filed: Aug. 7, 2003

(51) Int. Cl. B08B 13/00

(52) U.S. Cl. 134/7; 134/6; 134/26; 134/10

(57) ABSTRACT

A method for treating fluid spills on a surface such as a roadway, shop, garage, or worksite includes placing a biodegradable absorbent material, such as coconut coir, onto the spill. Once the absorbent has absorbed the fluid spill, the absorbent along with the fluid may be safely disposed in a landfill, swept or otherwise cleaned off the surface, or simply left at the spill location.

### BACKGROUND OF THE INVENTION

1. Related Applications

The following application claims the benefit of related Provisional Application No. 60/402,011, filed Aug. 8, 2002.

2. Field of the Invention

The present invention relates to a method for treating fluid spills on roadways, in shops, or on solid surfaces. In particular, the present invention relates to using a biodegradable absorbent material such as coconut coir to clean up fluid spills that occur on roadways as the result of automobile accidents and to clean up fluid spills of oils, solvents, or other fluids that occur in shops as well as in other situations.

3. State of the Art

Hundreds of thousands of motor vehicle accidents occur on roadways in the United States each year. While these accidents range in severity from relatively minor to extremely serious, a large number result in the release of fluids from the motor vehicles involved. These fluids can be radiator fluid, transmission fluid, power steering fluid, brake fluid, transmission fluid, engine oil, gasoline or any other of the fluids that are used in the operation of a motor vehicle and that tend to be released in an accident.

These fluids are generally non-water soluble and slippery. Thus, they present a hazard to other motor vehicles traveling in that area if left untreated on the road. In addition, many of these fluids present an environmental hazard if not properly cleaned up and disposed of.

It is often one of the functions of the police or the fire department in dealing with a motor vehicle crash site to clean up the spilled or leaked fluid on the road. This has traditionally been accomplished in one of several ways. Sometimes rags or absorbent paper will be used to sop up the spill. This method is messy and inconvenient as the rags or absorbent paper must be placed on the ground and then moved over the spill to “scrub” the spill area and absorb the fluid. This method frequently requires the operator to work on his or her hands and knees in order to manually “scrub” the spill. Additionally, after the spill has been absorbed, the rags or absorbent paper must be collected and taken to an appropriate waste disposal facility, depending on the nature of the fluid collected. These circumstances frequently make this method of cleanup relatively messy for the person performing it.

Another method for cleaning up such spills is to spread sand or kitty litter on the spill. With this method, the sand or kitty litter is spread over the spill and allowed to lay on the ground for a sufficient period of time to absorb the fluid. The sand or kitty litter is then shoveled or otherwise scraped up along with the absorbed fluid. Although this method is less messy than using rags or absorbent paper, materials such as sand and kitty litter are often not as absorbent as cloth or paper. In addition, the used sand or kitty litter must still be picked up and properly disposed of, which is often difficult due to the clumpy nature wet kitty litter. Furthermore, the silica dust which is present in kitty litter is an irritant to the lungs and can cause lung problems if repeatedly inhaled.

Additionally, spills of fuel, oil, solvents, thinners, etc. are common in home garages, shops, or warehouses. It is especially common to encounter these types of spills where automobiles or machinery is used or maintained.

Such spills present a significant problem for shops to clean and properly dispose of. Also of great concern is the disposal of such spills in a household environment where the average person does not know of the disposal requirements for the spilled fluid or does not have access to a suitable location to dispose of the fluid.

Some inventions, such as the Silva patent, U.S. Pat. No. 6,391,120, have addressed the issue of spill cleanup. Silva teaches the use of compressed coconut coir pieces ranging from one quarter inch to one and one half inch in diameter to cleanup oil spills on land or water. This size of coir piece would be ideally suited for cleanup of oil spills on water. Silva teaches broadcasting the pieces onto the oil spill with a blower type machine. The pieces will become submersed in the oil spill when they impact the surface of the oil and will absorb the oil without absorbing significant amounts of water. The large pieces of coir are also easily strained from the water for collection and reuse. The large pieces allows for the use of a large, coarse mesh sieve to separate the coir from the water. Smaller pieces would require a sieve with a much finer mesh. The finer mesh sieve would restrict the flow of water and make retrieval of the coir difficult.

The larger pieces taught by Silva are not, however well suited for cleanup of oil or fluid spills on land. On land, a fluid spill quickly flows into a thin film. A large piece of coir will contact the surface of the fluid film, contacting only a small portion of the coir. The greater portion of the coir remains dry and does not absorb the fluid.

Even if the entire surface of the coir were wetted with the fluid, much of the coir is still wasted because larger pieces of coir have an increasingly smaller surface area for a given weight of coir. The volume of a piece of coir increases proportionately to its diameter cubed while the surface area increases proportionately to the diameter squared. Smaller pieces of coir have a much greater surface area for a given weight of coir. This allows smaller coir to absorb more fluid from a fluid spill than an equal amount of larger coir, and the smaller coir will absorb the fluid more quickly.

Additionally, the large pieces of coir taught by Silva may present a hazard to vehicles or people in the vicinity of the fluid spill. Large pieces or coir are more likely to roll or blow around in the wind. Drivers seeing items rolling across the street may brake and cause accidents. Additionally, the larger pieces of coir could also cause a motor vehicle to lose traction as they provide a significant disruption to the contact between the tires of a vehicle and the road surface.

Due to these concerns, there is a need for a highly absorbent and easy to use material for cleaning up fluid spills on land, such as at accident sites and shops.

### SUMMARY OF THE INVENTION

It is an object of the present invention to provide a method for effectively cleaning up fluid spills on land such as at accident sites, shops, garages or warehouses.

It is another object of the invention to provide such a method which is relatively inexpensive and easy to use. It is yet another object of the present invention to provide a method of cleanup that is easy to dispose of after the cleanup is complete. The above and other objects of the present invention are accomplished by a method of cleaning up fluid spills at accident sites, pursuant to which, a pelletized, biodegradable absorbent material such as coconut coir or peat moss is spread on the spill and allowed to absorb the fluid. The absorbent material is then either collected for disposal, brushed off the side of the road, or left at the spill location.

In accordance with one aspect of the present invention, coconut coir is used as the biodegradable absorbent material. Coconut coir is a tough natural fiber derived from the processing of coconut husks. The long fibers are cleaned and compressed into bales and historically used as raw material for mats, car seat filler, furniture pads, geo-textiles, erosion control, rope, packaging, etc. Portions are also used for agricultural purposes for its soil beneficiation properties. Those properties include moisture retention, aeration, pH control in acid soils, and as a source of organic matter.

After the longer fibers are processed, the relatively short fibers remain. This product is known as coconut dust. The coconut dust is traditionally discarded as a waste by-product of the processing of the coconuts. The tremendous volume of coconut coir that is produced as a by-product of coconut processing has always presented a disposal problem to coconut processors. The coconut coir is generally left in large piles near the location where the coconuts are processed. Piles of discarded coconut coir can present health, fire and bio-hazards. In addition, they are a fertile habitat and breeding ground for species of beetles which are harmful to coconut trees.

However, coconut coir is a biodegradable plant material that can absorb up to nine times its weight in oil or other fluid, thereby allowing a relatively small amount of coconut coir to hold a substantial amount of oil or other fluid. In addition, because it holds the fluid tightly bonded to its fibers, the fluid does not tend to leach out after the coconut coir is disposed of in a landfill etc. While coconut coir is biodegradable, it breaks down very slowly. Thus, the coconut coir will hold the oil or other fluid for an extremely long time, thereby allowing naturally occurring microbes to break down the oil without releasing the oil or other fluid into the ground water or other environmentally sensitive areas. By turning the oil into substantially a solid, the oil/coir mixture can be safely disposed of in common landfills or even left by the roadside, thereby removing the need to reprocess or recycle the oil. Alternatively, the coconut coir can be swept off the side of the road where the coconut coir will hold the fluid trapped within its fibers until the fluid can be broken down and biodegraded by naturally occurring processes. Small pieces of coir can also be left at the spill location because they do not present either a biological hazard or a danger to passing persons or vehicles.

In another embodiment of the present invention, it has been found that a fluid spill on a roadway can be simply and effectively remediated by spreading peat moss on the fluid spill and allowing the peat moss to absorb the fluid spill. The peat moss containing the fluid can then be collected for disposal or simply swept off the road, leaving the road surface effectively clear of the spilled fluid.

One disadvantage of coconut coir or peat moss is that they are very light weight and can easily be disturbed by the wind. Thus, on breezy days it may be difficult to get the material to land on the liquid spill and to absorb the liquid before being blown away. Thus, in accord with another aspect of the invention, it has been found that the material can be pelletized. In pelletized form, the material is more dense and thus, not as susceptible to being blown around by the wind. Also, because pelletizing the material eliminates most of the small flakes and fibers, pellets are less messy to transport. The pellets can be stored in a reclosable container and transported to the location of the fluid spill. In addition, pellets can more easily be put down by hand, eliminating the need for a scoop or shovel to apply the material. Each pellet preferably contains at least 50% coconut coir and can additionally contain fire retardant chemicals, fertilizers, and/or materials that enhance the biodegradation of the spilled fluid.

In producing the coir pellets, it has been found that the powder containing coir, peat, or other additives is first mixed with an amount or water or other liquid to form a paste. The paste is then compressed and extruded into cylindrical pellets of approximately one eighth of an inch (0.12) to three sixteenths of an inch (0.19) in diameter and about one half of an inch long. The cylindrical pellets of coir mixture are then dried to remove the liquid and harden the pellets. The pellets are then passed through a chopper, a textured roller or series of rollers, or other device to break the cylindrical pellets into smaller pellets ranging from between one sixteenth (0.06) to three sixteenth (0.19) inch in diameter. The coarse and roughly spherical pellets of coir have a rough exterior that more quickly absorbs the spilled fluid than a hard pressed surface would. The small pellets have a high surface area for a given weight. The pellets also are sufficiently large so as to limit the risk of being blown around while spreading the pellets. Additionally, the pellets are small enough to be barely noticeable to a driver.

Additionally, because the pellets are small they do not present a hazard to passing persons or vehicles. Because the coir also absorbs the oil so strongly so as to not release the oil into the environment, the coir may then may be left at the spill location. This is a great advantage in cleaning vehicle accident spills because the attending police officer is in danger while remaining in the road to sweep or shovel up the fluid absorbing material. Cleanup is also improved for an individual cleaning up a spill at their home. The coir strongly absorbs the liquid spill allowing disposal of the liquid in the trash or easy transportation to another conventional place of disposal without waste of a significant amount of coir.

### BRIEF DESCRIPTION OF THE DRAWINGS

The above and other objects, features and advantages of the invention will become apparent from a consideration of the following detailed description presented in connection with the accompanying drawings in which:

FIG. 1 shows coconut coir placed on a surface such as a roadway for the purpose of absorbing fluid that has spilled on the surface.

FIG. 2 shows pellets containing coconut coir being deposited on a surface such as a roadway.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention and should not be viewed as narrowing the pending claim.

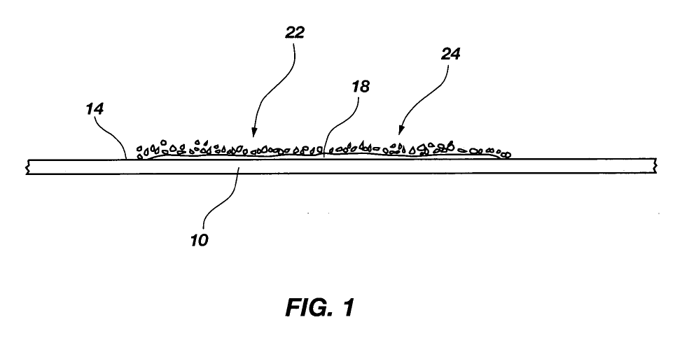

Turning to FIG. 1, there is shown a side view of a roadway, generally indicated at 10, which contains on its upper surface 14 fluid leaked from a motor vehicle such as radiator fluid, motor oil, etc. generally indicated at 18. Biodegradable absorbent material 22, illustrated in FIG. 1 for example as coconut coir or peat moss 24 is generally disposed about the upper surface 14 of the roadway in such a manner as to come into contact with and absorb the fluid 18.

Because of the strong absorbing action of the coconut coir 24 relative to the fluid 18, the coconut coir 24 holds the fluid and will not release any significant amount of the fluid 18 into the surrounding environment for a sufficiently long period of time, that naturally occurring microbes will have the ability to break down the fluid 18. Thus the coconut coir can be safely disposed of in municipal landfills or simply swept off the side of the road. Additionally, the coir can be left on the roadway because its small size does not present a hazard to passing vehicles or pedestrians.

Most preferably, the coconut coir 24 is processed to remove the long fibers used for making rope and fabric, so that small pieces of the husk remain. The coir is then processed into small pellets, between 0.06 and 0.19 inches in diameter.

Coconut coir 24 is desirable as the absorbent material 22 because of its ability to absorb up to nine times its weight in oil or other motor vehicle fluids. Additionally, it is highly advantageous because it does not release any significant amounts of the oil or other motor vehicle fluids even when it is exposed to water or other environmental conditions which would cause many other absorbents to release the oil or other motor vehicle fluids.

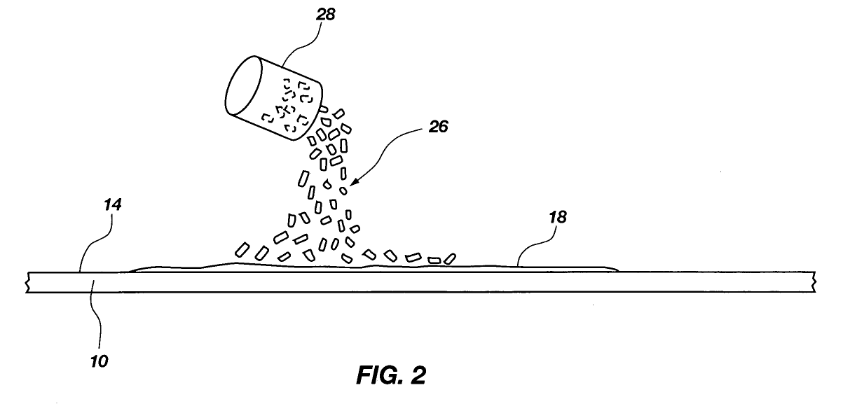

In accordance with another aspect of the invention, FIG. 2 illustrates a method for cleaning spills utilizing pellets 26, containing coconut coir. The pellets 26 are shown being poured from a container 28 in which they were stored. Because of their density, the pellets 26 fall more or less straight down from the container 28 onto the fluid 18 which has leaked onto the roadway 10 despite the effect of any winds that might be present.

The pellets, because of their size, then remain in place on the roadway without creating a hazard to vehicles or pedestrians. In a similar manner, small pellets of coir may be used to clean up fluid spills in a variety of situations including shops, garages, warehouses, or worksites. The safety and efficiency of the cleanup is increased with the use of small coconut coir pellets.

Small pellets are thus advantageous for cleaning liquid spills on surfaces such as roadways or in shops. The smaller pellets have much more surface area than a equivalent weight of large pellets. The greater surface area of small pellets allows the pellets to absorb the liquid much more quickly and absorb much more liquid for the same weight of coir. The smaller pellets also spread more evenly and completely over the spill, more completely removing the liquid. The smaller pellets are also safer to use than larger pellets because they are less likely to roll away or blow around in the wind, and are less visible. Motorists may be distracted or alarmed by large pellets, potentially creating another dangerous situation, but will not be affected in such manner by smaller pellets. Smaller pellets also are much less likely to cause the loss of traction for passing motorists or pedestrians that is likely caused when a large pellet seriously disrupts the contact between a tire or shoe and the roadway.

Thus there is disclosed an improved method for treating fluid spills on roadways. Those skilled in the art will appreciate numerous modifications which can be made without departing from the scope and spirit of the present invention. The appended claims are intended to cover such modifications.

1. A method for treating fluid spills on roadways comprising:
placing a biodegradable absorbent material selected from a group consisting of peat moss and coconut coir onto a roadway where there has been a fluid spill, said material being pellets having an average diameter of 3/16 of an inch or smaller; and
removing the absorbent from the roadway.

2. The method for treating fluid spills of claim 1, wherein the absorbent is coconut coir dust.

3. The method for treating fluid spills according to claim 2 wherein the method further comprises disposing of the absorbent by sweeping it off the road.

4. The method for treating fluid spills according to claim 1, wherein the method further comprises disposing of the absorbent in a landfill.

5. The method of claim 1 wherein the pellets comprise a fire retardant.

6. The method of claim 1 wherein the pellets comprise at least 50% coconut coir.

7. The method of claim 1 wherein the pellets comprise a material for enhancing the biodegradation of the fluid.

8. A method for containing fluid spilled on a surface comprising:
identifying fluid spilled on a surface; and
covering the fluid spill with coconut coir pellets having an average diameter of 3/16 of an inch or less.

9. The method of claim 8 further comprising removing the coconut coir.

10. The method of claim 8 wherein the coconut coir comprises pellets.

11. The method of claim 10 wherein the pellet size is roughly between 0.06 and 0.12 inches in diameter.

12. The method of claim 10 wherein the coconut coir pellets comprise a fire retardant.

13. The method of claim 10 wherein the coconut coir pellets comprise material for enhancing biodegradation of the fluid.

14. The method according to claim 8 wherein the method comprises leaving the coir on the surface.

15. A method for transporting coconut coir, the method comprising:
selecting pellets formed from at least 50% coconut coir by weight, said pellets having an average diameter of 3/16 inch or less;
placing the pellets in a recloseable container; and
transporting the recloseable container to a location having a fluid spill.

16. The method of claim 15 further comprising spreading the pellets on a fluid spill.

17. The method of claim 16 further comprising leaving the pellets on the fluid spill.

18. The method of claim 16 further comprising disposing of the pellets by sweeping them off the surface.

19. The method of claim 15 further comprising disposing of the pellets by disposing of them in a landfill.

20. The method according to claim 16 further comprising leaving the pellets on the surface.

21. The method according to claim 15 wherein the pellets are roughly between 0.06 and 0.12 inches in diameter.

22. A method for manufacturing coconut coir pellets comprising:
mixing the coir with liquid to form a paste;
extruding the paste into cylindrical pellets of approximately 0.19 inches in diameter and between 0.18 and 1.5 inches long;
drying the cylindrical pellets to remove the liquid and harden the pellet; and
breaking the cylindrical pellets into pieces ranging from approximately 0.06 to approximately 0.19 inches in diameter.

23. A method for cleaning up spilled liquid comprising:
covering the liquid with coconut coir pellets having a size ranging from approximately 0.06 to approximately 0.19 inches in diameter.

24. The method according to claim 25 further comprising disposing of the used coir pellets in a landfill.

25. The method according to claim 25 further comprising leaving the pellets at the spill location.
